(19) United States
(12) Patent Application Publication
(10) Pub. No.: US 2019/0105731 A1
(43) Pub. Date: Apr. 11, 2019

(54) HOT FORMED BONDING IN SHEET METAL PANELS

(71) Applicant: GM Global Technology Operations LLC, Detroit, MI (US)

(72) Inventors: Eric S. Nielsen, Sterling Heights, MI (US); Adam R. Ballard, Chesterfield, MI (US); Robert N. Saje, Shelby Township, MI (US)

(73) Assignee: GM Global Technology Operations LLC, Detroit, MI (US)

(21) Appl. No.: 15/727,145

(22) Filed: Oct. 6, 2017

(51) Int. Cl. B23K 20/02; B21D 26/021; C21D 9/50; B23K 37/00

(52) U.S. Cl. CPC B23K 20/023; B23K 37/003; C21D 9/505; B21D 26/021

(57) ABSTRACT

A method for bonding metal workpieces includes: (a) heating a plurality of metal workpieces until the metal workpieces are fully annealed; (b) applying pressure to the metal workpieces to compress the metal workpieces together while the metal workpieces are still heated until the metal workpieces fuse together; and (c) actively cooling the metal workpieces while the metal workpieces are compressed together to join the metal workpieces together.

### INTRODUCTION

The present disclosure relates to a method for bonding sheet metal panels. In particular, the present disclosure relates to a hot formed bonding method for sheet metal panels.

### SUMMARY

The present disclosure describes a method for bonding metal workpieces solely using heat transfer and pressure, thereby minimizing cost, reducing overall system mass and scrap, and reducing floor space required for additional joining operations. The presently disclosed method allows bonding of metallic workpieces without the use of traditional method of bonding such as hemming, chemical adhesives, fasteners, welding, and soldering. The workpieces can come out of the tool ready for the next manufacturing step without having to go through an additional assembly operations.

In certain embodiments, the method includes: (a) heating a plurality of metal workpieces until the metal workpieces are fully annealed; (b) applying pressure to the metal workpieces to compress the metal workpieces together while the metal workpieces are still heated until the metal workpieces fuse together; and (c) actively cooling the metal workpieces while the metal workpieces are compressed together to join the metal workpieces together. As a non-limiting example, the metal workpieces may be actively cooled for five seconds to fifteen seconds. The metal workpieces, however, may be actively cooled for more or less time depending on the materials to be joined and the desired mechanical properties. As a non-limiting example, the metal workpieces are actively cooled until the metal workpieces reach eighty degrees Fahrenheit or less. This temperature, however, depends on the materials to be joined and the desired mechanical properties. The method is characterized by an absence of hemming. The method is characterized by an absence of a use of a chemical adhesive. The method is characterized by an absence of a use of a fastener. The method is characterized by an absence of welding. The method is characterized by an absence of soldering. At least one of the metal workpieces includes steel, and heating the plurality of metal workpieces includes heating the plurality of the workpieces at a temperature that is, for example, between 1400 degrees Fahrenheit and 1600 degrees Fahrenheit. This temperature, however, depends on the materials to be joined and the desired mechanical properties. At least one of the metal workpieces includes aluminum, and heating the plurality of metal workpieces includes heating the plurality of workpieces at a temperature that is, for example, between 600 and 800 degrees Fahrenheit. This temperature, however, depends on the materials to be joined and the desired mechanical properties. Applying pressure to the metal workpieces includes pressing the metal workpieces in a die to form the metal workpieces into a predetermined shape, and actively cooling the metal workpieces includes quenching the metal workpieces at the same time as the metal workpieces are being compressed together in the die. Applying pressure to the metal workpieces includes roll forming the metal workpieces, and actively cooling the metal workpieces includes quenching the metal workpieces at the same time as the metal workpieces are being rolled formed. At least one of the metal workpieces is a metal structure selected from a group consisting of blanks, rolls, panels, fasteners, and coils. The metal workpieces have different sizes or the same sizes.

In certain embodiments, each of the metal workpieces includes steel. Heating the plurality of metal workpieces until the metal workpieces are fully annealed includes heating the metal workpieces in a die until each of the metal workpieces has a temperature that is, for example, between 1400 degrees Fahrenheit and 1600 degrees Fahrenheit. This temperature, however, depends on the materials to be joined and the desired mechanical properties. The method further includes removing the metal workpieces from the furnace. The method further includes placing the metal workpieces in a die while the temperature of each of the metal workpieces is greater than, for example, 1400 degrees Fahrenheit. This temperature, however, depends on the materials to be joined and the desired mechanical properties. Applying pressure to the metal workpieces to compress the metal workpieces together while the metal workpieces are still heated until the metal workpieces fuse together includes pressing the metal workpieces in the die to form a one-piece structure metal having a predetermined shape at the same time as the temperature of each of the metal workpieces is greater than, for example, 1400 degrees Fahrenheit. This temperature, however, depends on the materials to be joined and the desired mechanical properties. Actively cooling the metal workpieces includes quenching the metal workpieces with a liquid coolant for fifteen seconds at the same time as the metal workpieces are being compressed together in the die. The method solely employs heat transfer and pressure to join the metal workpieces together. The method is characterized by an absence of hemming, the method is characterized by an absence of a chemical adhesive, the method is characterized by an absence of a fastener, the method is characterized by an absence of welding, the method is characterized by an absence of soldering, the metal workpieces are in direct contact with each other when the pressure is applied to compress the metal workpieces together, and each of the metal workpieces is a panel.

In certain embodiments, each of the metal workpieces includes aluminum. Heating the plurality of metal workpieces until the metal workpieces are fully annealed includes heating the metal workpieces in a furnace until each of the metal workpieces has a temperature that is, for example, between 600 degrees Fahrenheit and 800 degrees Fahrenheit. This temperature, however, depends on the materials to be joined and the desired mechanical properties. The method further includes removing the metal workpieces from the furnace, the method further includes placing the metal workpieces in a die while the temperature of each of the metal workpieces is, for example, greater than 600 degrees Fahrenheit. The plurality of metal workpieces includes a first metal workpiece and a second metal workpiece. The first metal workpiece has a first size. The second metal workpiece has a second size. The first size is different from the second size. Applying pressure to the metal workpieces to compress the metal workpieces together while the metal workpieces are still heated until the metal workpieces fuse together includes pressing the metal workpieces in the die to form a one-piece structure having a predetermined shape at the same time as the temperature of each of the metal workpieces is, for example, greater than 600 degrees Fahrenheit. Actively cooling the metal workpieces includes quenching the metal workpieces with a liquid coolant for fifteen seconds at the same time as the metal workpieces are being compressed together in the die. The method solely employs heat transfer and pressure to join the metal workpieces together. The method is characterized by an absence of hemming, the method is characterized by an absence of a chemical adhesive. The method further includes removing the one-piece structure from the die. The method is characterized by an absence of a fastener. The method is characterized by an absence of welding, the method is characterized by an absence of soldering. The metal workpieces are in direct contact with each other when the pressure is applied to compress the metal workpieces together. Each of the metal workpieces is a panel.

In certain embodiments, the method includes (a) heating a plurality of metal workpieces until the metal workpieces are fully annealed; (b) applying pressure to the metal workpieces to compress the metal workpieces together while the metal workpieces are still heated until the metal workpieces fuse together; and (c) actively cooling the metal workpieces while the metal workpieces are compressed together to join the metal workpieces together, wherein actively cooling the metal workpieces includes quenching the metal workpieces with a coolant at the same time as the metal workpieces are compressed together. The metal workpieces are actively cooled for five seconds to fifteen seconds. The metal workpieces are actively cooled until the metal workpieces reach eighty degrees Fahrenheit or less.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a flowchart of a method for bonding metal workpieces.

FIG. 2 is a flowchart of a method for bonding metal workpieces according to an embodiment of the present disclosure.

FIG. 3 is a flowchart of a method for bonding metal workpieces according to another embodiment of the present disclosure.

### DETAILED DESCRIPTION

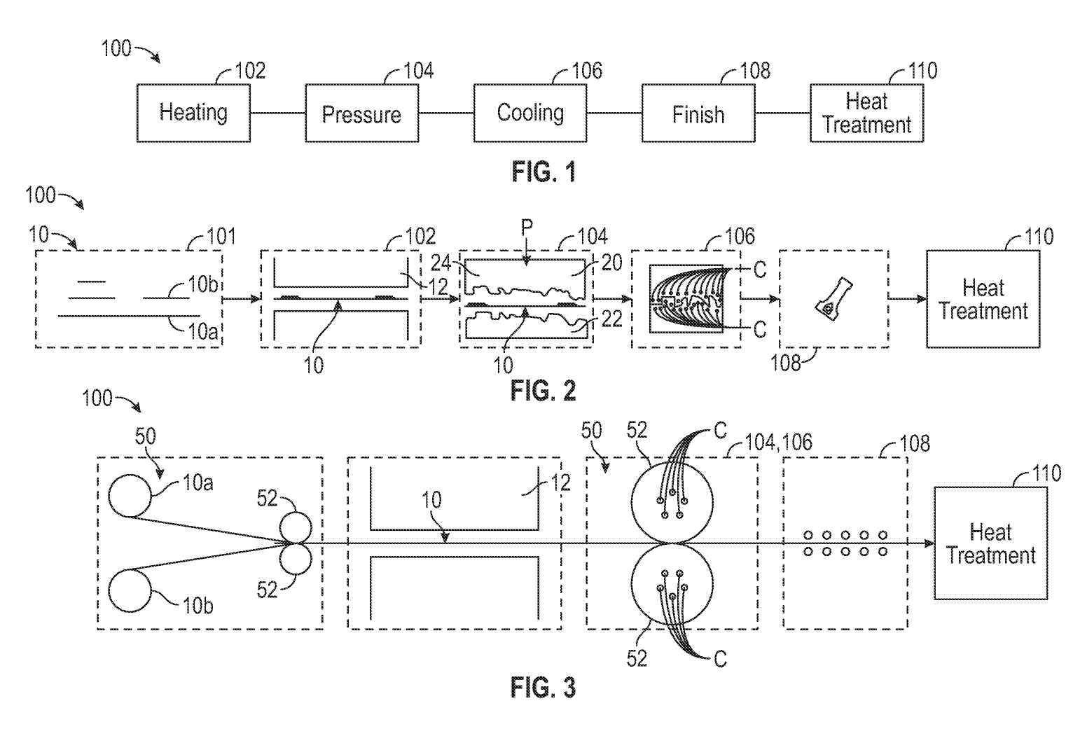

With reference to FIGS. 1-3, the present disclosure describes a method 100 for bonding a plurality of metal workpieces 10 together. In this method 100, heat transfer and pressure are solely used to join the metal workpieces 10 together and thereby form a one-piece structure having a predetermined shape. Accordingly, the method 100 does not employ hemming, chemical adhesives, fasteners, welding, and/or soldering to join the metal workpieces 10 together. The metal workpieces 10 may be wholly or partly made, for example, of steel, aluminum or any other suitable metallic material. Further, one or more of the metal workpieces 10 may be blanks, rolls, panels, fasteners, coil and/or panels. The method 100 can be used to bond steel-to-steel, aluminum-to-aluminum, aluminum-to-steel, aluminum-to-other non-ferrous metals, and steel-to-other non-ferrous metals. For example, an entire coil with a variable thickness can be created using this method 100. In the depicted embodiment, at least a first metal workpiece 10a and a second metal workpiece 10b can be bonded together. However, it is contemplated that more than two metal workpieces 10 can be joined together using the method 100. The first metal workpiece 10a and the second metal workpiece 10b may the same size or different sizes. It may be desirable to bond metal workpieces 10 of the same size (e.g., panels) to minimize splitting/thinning, eliminate assembly fixture, and create a material sandwich. It may be desirable to bond metal workpieces 10 having different sizes (e.g., flanges) to add thickness locally to fix a weld, eliminate assembly fixtures, add local stiffness (i.e., reinforcement), add material for joint strength, reduce rat hole size, and create a material sandwich. For example, an additional reinforcement could be added to thicken an area where a stud or nut is applied (i.e. local reinforcement).

In certain embodiments, the method 100 begins at step 101, in which metal workpieces 10 in the form of blanks are stacked together as shown in FIG. 2 (i.e., the stamping process). Alternatively, at step 101, metal workpieces 10 in the form of coils are uncoiled as shown in FIG. 3 (i.e., the roll forming process). Then, the method proceeds to step 102. At step 102, metal workpieces 10 are heated until the metal workpieces 10 are fully annealed to promote fusion. This heating may be performed in a furnace 12 (as shown in FIGS. 2 and 3), an oven, or any other suitable device capable of applying heat to the metal workpieces 10. In the case that the metal workpieces 10 are made of steel, for example, the metal workpieces 10 are heated, for example in the furnace 12, until the temperature of these metal workpieces 10 is between 1400 and 1600 degrees Fahrenheit to allow the metal workpieces 10 to fully anneal. In the case that the metal workpieces 10 are made of aluminum, the metal workpieces 10 are heated, for example in the furnace 12 or oven, until the temperature of the metal workpieces 10 is between 600 and 800 degrees Fahrenheit to allow the metal workpieces 10 to fully anneal. Thereafter, the metal workpieces 10 are removed from the furnace 12 and oven. Then, the method 100 proceeds to step 104.

At step 104, the metal workpieces 10 are placed in an apparatus capable of applying pressure P to the metal workpieces 10, such as a die 20 (shown in FIG. 2) or a roller assembly 50 (shown in FIG. 3), while the metal workpieces are still heated. While pressure P is applied, the metal workpieces 10 are in direct contact with each other to facilitate fusion. In the case of steel, the metal workpieces are placed in the compressing apparatus, for example in the die 20 or the roller assembly 50, at the same time as the temperature of each of the metal workpieces 10 is greater than 1400 degrees Fahrenheit to facilitate fusion. In the case of aluminum, the metal workpieces are placed in the compressing apparatus, such as the die 20 or the roller assembly 50, at the same time as the temperature of each metal workpiece is greater than 600 degrees to facilitate fusion. As shown in FIG. 2, the die 20 may include a first die part 22 and a second die part 24 movable relative to the first die part 22 to apply pressure P to the metal workpieces 10. Step 104 also entails applying pressure to the metal workpieces 10 to compress the metal workpieces 10 together while the metal workpieces 10 are still heated until the metal workpieces 10 fuse together. In the case of steel, the metal workpieces 10 are compressed, for example in the die 20, at the same time as the temperature of each of the metal workpieces 10 is greater than 1400 degrees Fahrenheit to facilitate fusion. In the case of aluminum, the metal workpieces 10 are compressed, for example in the die 20 or the roller assembly 50, at the same time as the temperature of each metal workpiece 10 is greater than 600 degrees to facilitate fusion. As shown in FIG. 3, the roller assembly 50 includes at least two rotatable rollers 52 positioned to compress the metal workpieces 10 together. Thus, step 104 may entail roll forming the metal workpieces 10 together. Next, the method 100 proceeds to step 106.

At step 106, the metal workpieces 10 are actively cooled at the same time as the metal workpieces 10 are compressed together, by for example the die 20 or the roller assembly 50, in order to join (i.e., fuse) the metal workpieces 10 together, thereby forming a one-piece structure. In some embodiments, the metal workpieces 10 are actively cooled for five to fifteen seconds until the metal workpieces 10 reach a temperature of eighty degrees Fahrenheit or less to facilitate handling during subsequent processes. At step 106, the cooling process may entail quenching the metal workpieces 10, with a liquid or gaseous coolant C, at the same time as the metal workpieces 10 are being compressed together in the die 20 (shown in FIG. 2) or the roller assembly 50 (shown in FIG. 3) through roll forming. The coolant C may be air, water, oil, or any other coolant suitable to cool the metal workpieces 10. Next, the method 100 proceeds to step 108.

At step 108, the one-p structure can be subjected to a subsequent manufacturing process to form a finished or final part. For instance, as shown in FIG. 2, the one-piece structure may be trimmed. Then, the method 100 proceeds to step 110. At step 110, the finished or final part may be subjected to any suitable heat treatment.

While the best modes for carrying out the disclosure have been described in detail, those familiar with the art to which this disclosure relates will recognize various alternative designs and embodiments for practicing the disclosure within the scope of the appended claims.

What is claimed is:

1. A method, comprising:
heating a plurality of metal workpieces until the metal workpieces are fully annealed;
applying pressure to the metal workpieces to compress the metal workpieces together while the metal workpieces are still heated until the metal workpieces fuse together; and
actively cooling the metal workpieces while the metal workpieces are compressed together to join the metal workpieces together.

2. The method of claim 1, wherein the metal workpieces are actively cooled for five seconds to fifteen seconds.

3. The method of claim 1, wherein the metal workpieces are actively cooled until the metal workpieces reach eighty degrees Fahrenheit.

4. The method of claim 1, wherein the method is characterized by an absence of hemming.

5. The method of claim 1, wherein the method is characterized by an absence of a use of a chemical adhesive.

6. The method of claim 1, wherein the method is characterized by an absence of a use of a fastener.

7. The method of claim 1, wherein the method is characterized by an absence of welding.

8. The method of claim 1, wherein the method is characterized by an absence of soldering.

9. The method of claim 1, wherein at least one of the metal workpieces includes steel, and heating the plurality of metal workpieces includes heating the plurality of the metal workpieces at a temperature that is between 1400 degrees Fahrenheit and 1600 degrees Fahrenheit.

10. The method of claim 1, wherein at least one of the metal workpieces includes aluminum, and heating the plurality of metal workpieces includes heating the plurality of workpieces at a temperature that is between 600 and 800 degrees Fahrenheit.

11. The method of claim 1, wherein applying pressure to the metal workpieces includes pressing the metal workpieces in a die to form the metal workpieces into a predetermined shape, and actively cooling the metal workpieces includes quenching the metal workpieces at the same time as the metal workpieces are being compressed together in the die.

12. The method of claim 1, wherein applying pressure to the metal workpieces includes roll forming the metal workpieces, and actively cooling the metal workpieces includes quenching the metal workpieces at the same time as the metal workpieces are being rolled formed.

13. The method of claim 1, wherein at least one of the metal workpieces is a metal structure selected from a group consisting of blanks, rolls, panels, fasteners, and coils.

14. The method of claim 1, wherein the metal workpieces have different sizes.

15. The method of claim 1, wherein each of the metal workpieces includes steel, heating the plurality of metal workpieces until the metal workpieces are fully annealed includes heating the metal workpieces in a furnace until each of the metal workpieces has a temperature that is between 1400 degrees Fahrenheit and 1600 degrees Fahrenheit, the method further includes removing the metal workpieces from the furnace, the method further includes placing the metal workpieces in a die while the temperature of each of the metal workpieces is greater than 1400 degrees Fahrenheit, applying pressure to the metal workpieces to compress the metal workpieces together while the metal workpieces are still heated until the metal workpieces fuse together includes pressing the metal workpieces in the die to form a one-piece structure metal having a predetermined shape at the same time as the temperature of each of the metal workpieces is greater than 1400 degrees Fahrenheit, actively cooling the metal workpieces includes quenching the metal workpieces with a liquid coolant for fifteen seconds at the same time as the metal workpieces are being compressed together in the die, the method solely employs heat transfer and pressure to join the metal workpieces together, the method is characterized by an absence of hemming, the method is characterized by an absence of a chemical adhesive, the method is characterized by an absence of a fastener, the method is characterized by an absence of welding, the method is characterized by an absence of soldering, the metal workpieces are in direct contact with each other when the pressure is applied to compress the metal workpieces together, and each of the metal workpieces is a panel.

16. The method of claim 1, wherein each of the metal workpieces includes aluminum, heating the plurality of metal workpieces until the metal workpieces are fully annealed includes heating the metal workpieces in a furnace until each of the metal workpieces has a temperature that is between 600 degrees Fahrenheit and 800 degrees Fahrenheit, the method further includes removing the metal workpieces from the furnace, the method further includes placing the metal workpieces in a die while the temperature of each of the metal workpieces is greater than 600 degrees Fahrenheit, the plurality of metal workpieces include a first metal workpiece and a second metal workpiece, the first metal workpiece has a first size, the second metal workpiece has a second size, the first size is different from the second size, applying pressure to the metal workpieces to compress the metal workpieces together while the metal workpieces are still heated until the metal workpieces fuse together includes pressing the metal workpieces in the die to form a one-piece structure having a predetermined shape at the same time as the temperature of each of the metal workpieces is greater than 600 degrees Fahrenheit, actively cooling the metal workpieces includes quenching the metal workpieces with a liquid coolant for fifteen seconds at the same time as the metal workpieces are being compressed together in the die, the method solely employs heat transfer and pressure to join the metal workpieces together, the method is characterized by an absence of hemming, the method is characterized by an absence of a chemical adhesive, the method further includes removing the one-piece structure from the die, the method is characterized by an absence of a fastener, the method is characterized by an absence of welding, the method is characterized by an absence of soldering, the metal workpieces are in direct contact with each other when the pressure is applied to compress the metal workpieces together, and each of the metal workpieces is a panel.

17. A method, comprising:
heating a plurality of metal workpieces until the metal workpieces are fully annealed;
applying pressure to the metal workpieces to compress the metal workpieces together while the metal workpieces are still heated until the metal workpieces fuse together; and
actively cooling the metal workpieces while the metal workpieces are compressed together to join the metal workpieces together; and
wherein actively cooling the metal workpieces includes quenching the metal workpieces with a coolant at the same time as the metal workpieces are compressed together.

18. The method of claim 17, wherein the metal workpieces are actively cooled for five seconds to fifteen seconds.

19. The method of claim 17, wherein the metal workpieces are actively cooled until the metal workpieces reach eighty degrees Fahrenheit.

20. The method of claim 17, wherein each of the metal workpieces includes aluminum, heating the plurality of metal workpieces until the metal workpieces are fully annealed includes heating the metal workpieces in a furnace until each of the metal workpieces has a temperature that is between 600 degrees Fahrenheit and 800 degrees Fahrenheit, the method further includes removing the metal workpieces from the furnace, the method further includes placing the metal workpieces in a die while the temperature of each of the metal workpieces is greater than 600 degrees Fahrenheit, the plurality of metal workpieces include a first metal workpiece and a second metal workpiece, the first metal workpiece has a first size, the second metal workpiece has a second size, the first size is different from the second size, applying pressure to the metal workpieces to compress the metal workpieces together while the metal workpieces are still heated until the metal workpieces fuse together includes pressing the metal workpieces in the die to form a one-piece structure having a predetermined shape at the same time as the temperature of each of the metal workpieces is greater than 600 degrees Fahrenheit, actively cooling the metal workpieces includes quenching the metal workpieces with a liquid coolant for fifteen seconds at the same time as the metal workpieces are being compressed together in the die, the method solely employs heat transfer and pressure to join the metal workpieces together, the method is characterized by an absence of hemming, the method is characterized by an absence of a chemical adhesive, the method further includes removing the one-piece structure from the die, the method is characterized by an absence of a fastener, the method is characterized by an absence of welding, the method is characterized by an absence of soldering, the metal workpieces are in direct contact with each other when the pressure is applied to compress the metal workpieces together, and each of the metal workpieces is a panel, and the metal workpieces are actively cooled until the metal workpieces reach eighty degrees Fahrenheit.
